(19) United States
(12) Patent Application Publication
(10) Pub. No.: US 2009/0181752 A1
(43) Pub. Date: Jul. 16, 2009

(54) Gaming Machine

(75) Inventor: Hiroyuki NAGANO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/177,455

(22) Filed: Jul. 22, 2008

Related U.S. Application Data
(60) Provisional application No. 61/020,472, filed on Jan. 11, 2008.

(51) Int. Cl. A63F 9/24; G06F 17/00

(52) U.S. Cl. 463/20; 463/29

(57) ABSTRACT

A gaming machine 1 includes a card reader 15. When a player inserts an ID card 112 into the card reader 15, player information stored in the ID 112 card is read by the card reader 15. The player information includes ID information with which the player can be identified. A message is generated based on the player information. A message is also generated based on game history information or insurance payout information in the gaming machine 1. Such messages are converted into Morse code. Thus-generated Morse code is represented with high-low, strong-weak, on-off and the like in sound effect outputted by a speaker 23, and also with change of color, light and dark, blinking and the like in light effect performed by a light emitting portion 20 and a topper effect device 28.

### CROSS-REFERENCE TO RELATED APPLICATIONS

This application is based upon and claims a priority from the U.S. Provisional Application No. 61/020,472 filed on Jan. 11, 2008, the entire contents of which are incorporated herein by reference.

### BACKGROUND

1. Field

The present invention relates to a gaming machine which outputs effects.

2. Description of Related Art

Conventionally, there have been such gaming machines as disclosed in U.S. Pat. No. 5,377,997 and U.S. Pat. No. 6,902,478 that conduct a game by interacting with a game or another player. In such a game, conversations are made relating to the game being conducted. Such conversations are necessary for enhancing entertaining aspect of a game.

Also, as disclosed in U.S. Pat. No. 6,171,186 and U.S. Pat. No. 6,213,875, demonstrations are carried out in many gaming machines.

However, in order to see the content of a demonstration, a player has to pay his/her attention to a screen on which the demonstration is being displayed. In this time, an interactive message concerning game history and the like is not provided to the player through the demonstration.

### SUMMARY

In view of the foregoing, one or more aspects of the present invention relate to a gaming machine which outputs effects in a new manner of representation.

In order to achieve the above object, according to a first aspect of the present invention, there is provided a gaming machine comprising: an effect device for outputting effect; a processor programmed to operate (1) to control an output state of the effect device by bringing into corresponding with Morse code that represents a message.

Furthermore, according to other aspect of the present invention, there is provided a gaming machine comprising: an effect device for outputting effect; a reader into which an ID card storing player information is inserted; a memory device for storing game history information; a setting device with which a player can set to an insurance mode in which an insurance payout is awarded on condition that a unit game is repeated for a certain number of times; and a processor programmed to operate (a-1) to read the player information with the reader when the ID card has been inserted into the reader, (a-2) to read the game history information from the memory device, (a-3) to generate insurance payout information on number of unit games which need to be repeated in order that the insurance payout is awarded, when the player set to the insurance mode with the setting device, (b) to generate the message based on the player information, the game history information or the insurance payout information, (c) to convert the message into Morse code, and (d) to control an output state of the effect device by bringing into corresponding with the Morse code.

### BRIEF DESCRIPTION OF THE DRAWINGS

FIG. 1 is a diagram for illustrating a feature of a gaming machine according to one embodiment of the present invention;

FIG. 2 is an external perspective view of the gaming machine;

FIG. 3 is a block diagram showing an internal configuration of the gaming machine;

FIG. 4 is a block diagram showing an internal configuration of a sub-control board;

FIG. 5 is a flowchart of a main control program;

FIG. 6 is a flowchart of a main game processing program;

FIG. 7 is a flowchart of a control program executed in the gaming machine;

FIG. 8 is a flowchart of a control program executed in the gaming machine;

FIG. 9 is a table for illustrating correspondences between play intervals and messages;

FIG. 10 is a table for illustrating correspondences between the number of wins and messages; and

FIG. 11 is a table for illustrating correspondences between the number of remaining games and messages.

### DETAILED DESCRIPTION

[1. General Description of the Invention]

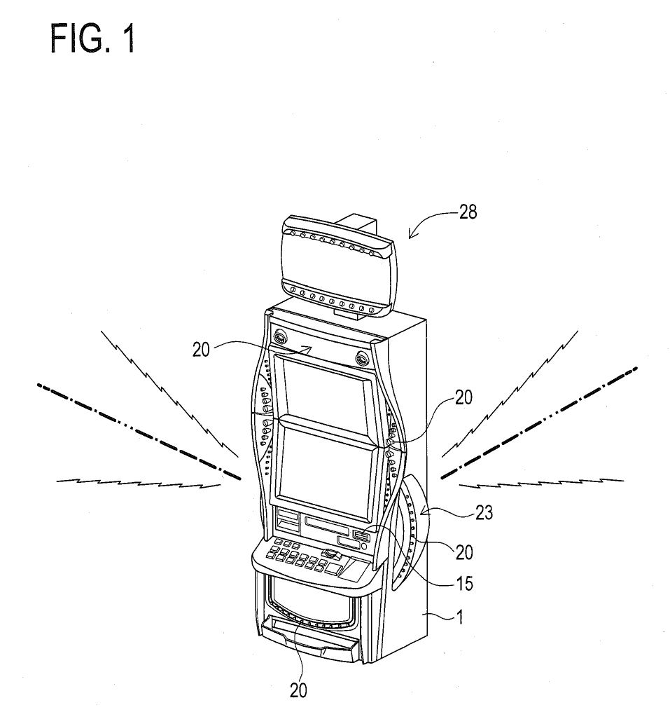

Embodiments of the present invention will be explained by referring to the drawings. FIG. 1 is a diagram for illustrating a feature of a gaming machine according to one embodiment of the present invention. A gaming machine 1 according to the present embodiment includes a plurality of effect devices such as a light emitting portion 20, a speaker 23 and a topper effect device 28.

The gaming machine 1 according to the present embodiment includes a card reader 15. When a player inserts an ID card into the card reader 15, player information stored in the ID card is read by the card reader 15. The player information includes ID information with which the player can be identified.

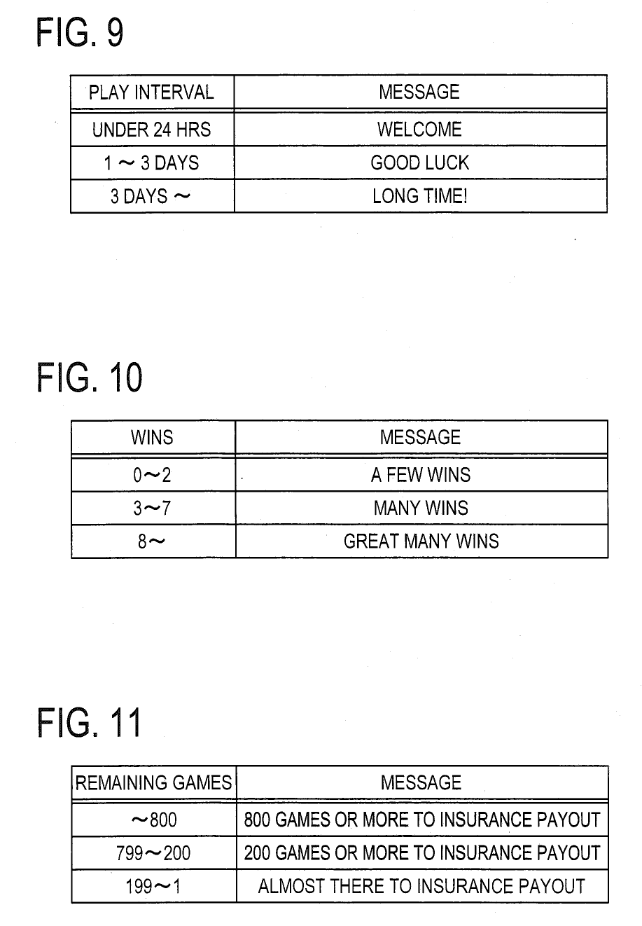

In the gaming machine 1 according to the present embodiment, a message is generated based on the player information. For instance, when it is known from the player information that the play interval of the player is three days or more, a message is generated “Long time!” (See FIG. 9 to be described later). Further, the message is converted into Morse code. The Morse code generated is represented with high-low, strong-week, on-off and the like in a sound effect outputted from the speaker 23 and also with change of color, light and dark, blinking and the like in a light effect performed by the light emitting portion 20 or the topper effect device 28.

Also in the gaming machine 1 of the present embodiment, a game such as a video slot is conducted. When the game is conducted, a unit game composing the game is performed repeatedly. The player can set to an insurance mode in which an insurance payout is awarded on condition that the unit game is repeated for a certain number of times. When set to the insurance mode, insurance payout information is generated and updated relating to the number of remaining games which need to be repeated in order that the insurance payout is awarded. A message is generated also from the insurance payout information (see FIG. 11 to be described later). Further, a message is generated from game history information of the gaming machine 1 of the embodiment (relating to the number of wins, for example) (see FIG. 10 to be described later). These messages are also converted to Morse code. The Morse code converted is represented with high-low, strong-week, and on-off and the like in a sound effect outputted from the speaker 23 and also with change of color, light and dark, blinking and the like in a light effect performed by the light emitting portion 20 or the topper effect device 28.

[2. Schematic Structure of the Gaming Machine]

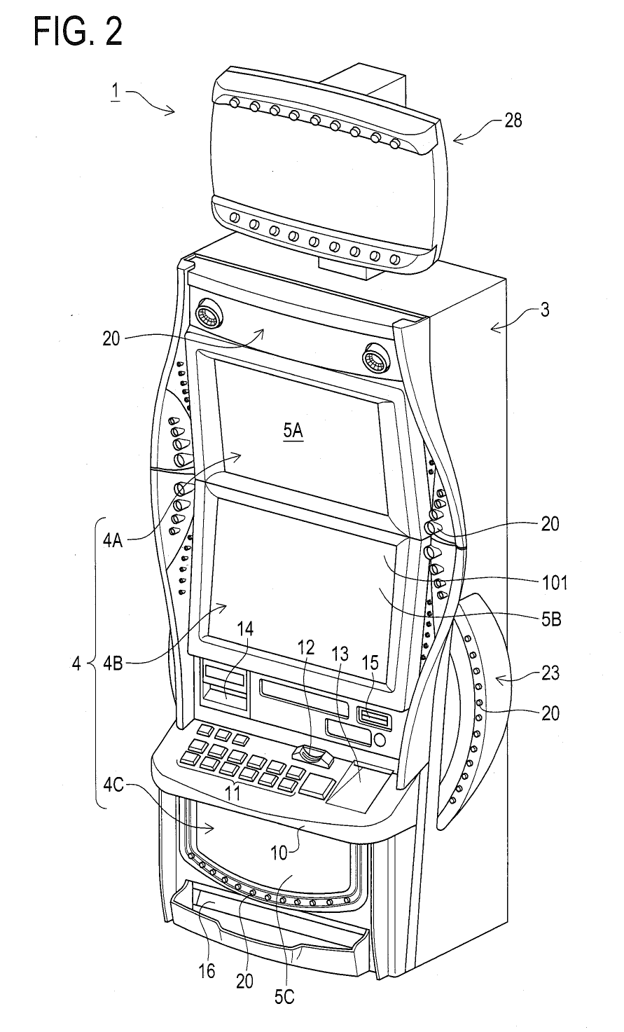

Next, a schematic structure of the gaming machine 1 will be described by referring to FIG. 2. FIG. 2 is an external perspective view of the gaming machine 1.

As shown in FIG. 2, the gaming machine 1 is of an upright type which is equipped with a game arcade such as casino and includes a cabinet 3 for housing electric or mechanical parts for conducting predetermined types of games. A display unit 4 for displaying information related to a game includes, for example, an upper display unit 4A, a variable display unit 4B at the middle stage of the display unit 4, and an under display unit 4C, which are installed at the front face of the cabinet 3 in a vertically long shape. The upper display unit 4A includes the liquid crystal panel 5A arranged at the upper side of the variable display unit 4B, the liquid crystal panel 5A for displaying an effecting images, an introduction of a game, or an explanation of game rules and the like. The under display unit 4C is arranged at the lower side of the variable display unit 4B and includes a plastic panel 5C on which an image is printed. The plastic panel 5C is lighted up with the backlight of the under display unit 4C.

The variable display unit 4B for displaying a state of a game includes the liquid crystal panel 5B which is fixed at a front door of the cabinet 3. The front face of the liquid crystal panel 5B includes a touch panel 101, with which a player can input various commands. The variable display unit 4B at the middle stage of the cabinet 3 is sloped so that the head of the variable display unit 4B tilts back to thereby allow the player to play a game in a comfortable position.

An operation table 10 extending forward is provided in between the variable display unit 4B at the middle stage and the under display unit 4C, on a front face of the cabinet 3. On the operation table 10, there are arranged operation buttons 11 including a BET button, a game start button, a collect button, a CASHOUT button, an insurance mode setting button and the like as an operation part for inputting instructions concerning a game conducted. The operation table 10 is provided with a coin insertion slot 12 and a bill insertion slot 13. A ticket printer 14 and a card reader 15 are provided in between the operation table 10 and the variable display unit 4B at the middle stage. The lowermost part of the cabinet 3 is provided with a coin tray 16.

As to the gaming machine 1, coins, bills or electronic value information (credit) corresponding to coins and bills are used as gaming media. However, in the present invention, types of gaming media are not restricted to the above. For example, medal, token, electronic money, ticket and the like are applicable as gaming media.

There are also arranged the light emitting portions 20 on the cabinet 3 of the gaming machine 1 so as to surround a game area including the upper display unit 4A, the variable display unit 4B at the middle stage, the under display unit 4C and the operation table 10.

The gaming machine 1 is further provided with the topper effect device 28 mounted on the cabinet 3. The topper effect device 28 is of a rectangular board shape and is arranged so as to be substantially parallel with the liquid crystal panel 5A of the upper display unit 4A. The cabinet 3 is further provided with speakers 23 on its both sides.

[3. Internal Configuration of the Gaming Machine]

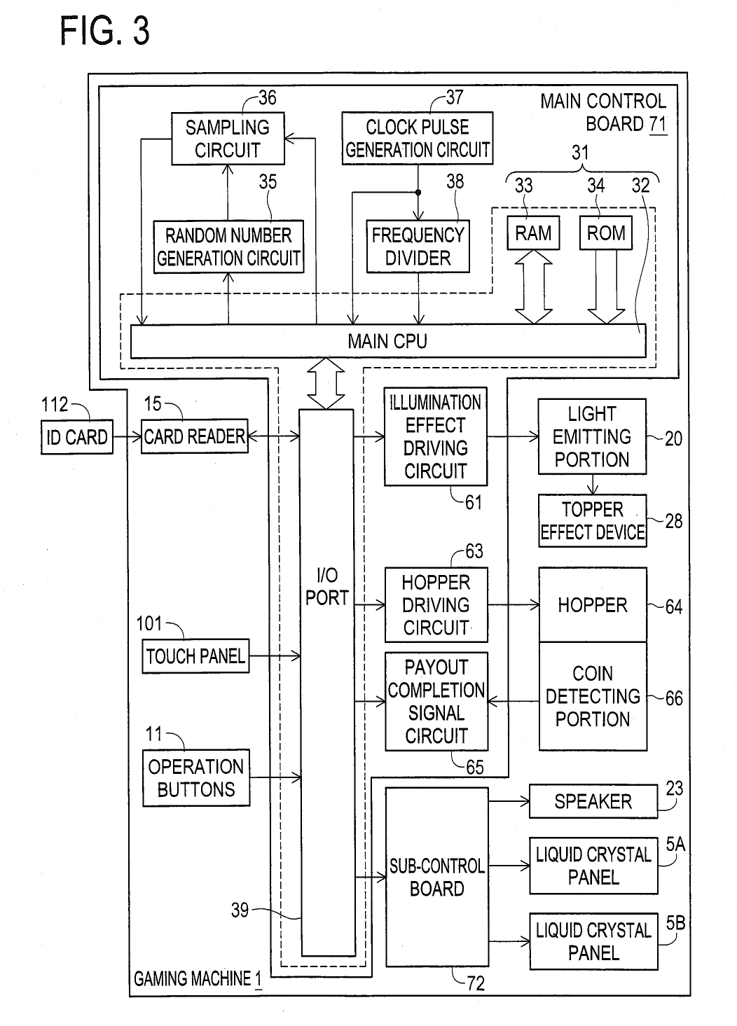

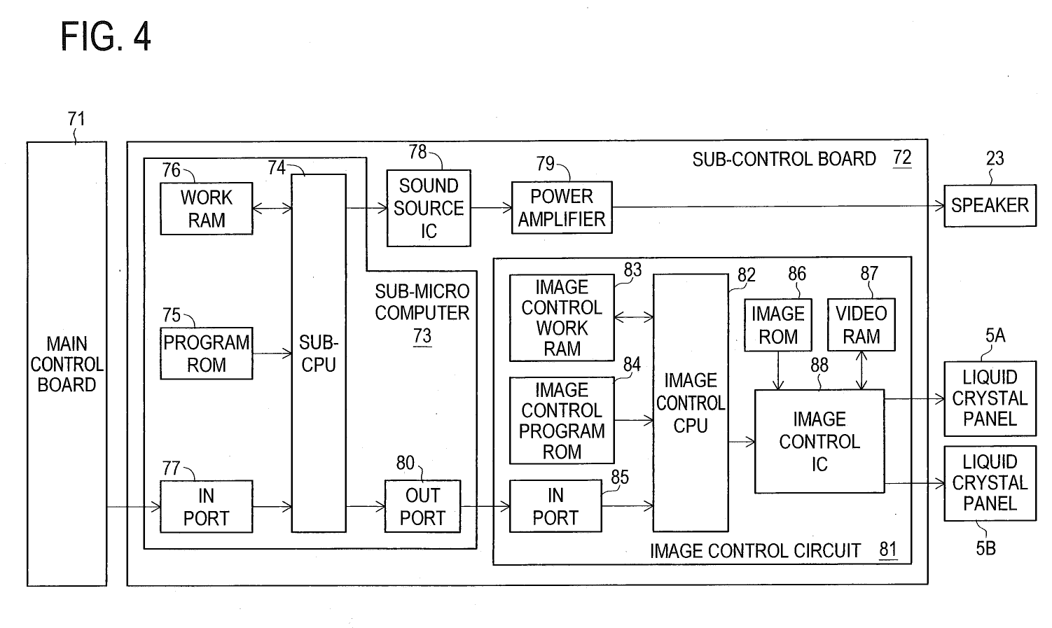

Next, an internal configuration of the gaming machine 1 will be explained by referring to FIGS. 3 and 4.

FIG. 3 is a block diagram showing an internal configuration of the gaming machine 1. As shown in FIG. 3, the gaming machine 1 includes a plurality of components such as a main control board 71 in which a microcomputer 31 is included. The main control board 71 includes the microcomputer 31, a random number generation circuit 35, a sampling circuit 36, a clock pulse generation circuit 37 and a frequency divider 38, and further includes an illumination effect driving circuit 61, a hopper driving circuit 63 and a payout completion signal circuit 65.

The microcomputer 31 includes a main CPU 32, a RAM 33 and a ROM 34. The main CPU 32 operates in accordance with the program stored in the ROM 34 and performs input and output to and from the other components via an I/O port 39 to carry out an operation control over the gaming machine 1. The RAM 33 stores data or programs to be used during an operation of the main CPU 32. For example, random numbers which are sampled by the after-mentioned sampling circuit 36 are stored temporarily after a start of the game in the RAM 33. Further, the RAM 33 temporarily stores the game history information, the insurance payout information, the messages, and the Morse code generated from the messages which were described above. The ROM 34 stores programs or static data (a table as shown in FIGS. 9 through 11, for example).

The programs stored in the ROM 34 include game programs and a game system program (hereinafter referred to as the game program and the like). The game programs further include a lottery program to be used while a game is conducted.

The random number generation circuit 35 is operated in accordance with an instruction of the main CPU 32 and generates random number within a certain range. In accordance with an instruction of the main CPU 32, the sampling circuit 36 extracts any random number from among the random numbers generated by the random number generation circuit 35 and inputs the extracted random number to the main CPU 32. The clock pulse generation circuit 37 generates a reference clock for operating the main CPU 32. The frequency divider 38 inputs a signal obtained by frequency-dividing the reference clock by a certain cycles to the main CPU 32.

Further, the card reader 15 is connected to the main control board 71. The card reader 15 can detect whether or not an ID card 112 is inserted. A signal in accordance with the detection is to be inputted to the main CPU 32 via the I/O port 39. Further, upon input of a drive signal from the main CPU 32, the card reader 15 reads the player information stored in the ID card 112. It is to be noted that the player information in the ID card 112 includes the ID information with which the player can be identified, as described above.

Further, a touch panel 101 is connected to the main control board 71. The touch panel 101 is arranged on the front face of the liquid crystal panel 5B and is capable of specifying a position in a coordinate touched by a player, and detecting a portion the player touched and which direction the touched portion has moved in accordance with the specified coordination position information. A signal corresponding to this detection is to be inputted to the main CPU 32 via the I/O port 39.

Further, the operation buttons 11 including the BET button, the game start button, the collect button, the CASHOUT button, the insurance mode setting button and the like are connected to the main control board 71. Signals corresponding to pushes of such buttons are inputted to the main CPU 32 via the I/O port 39.

The illumination effect driving circuit 61 outputs an effect signal for carrying out a light illumination effect with the above-described light emitting portion 20 and topper effect device 28. Further, the illumination effect driving circuit 61 stores data relating to the light effect described above. The topper effect device 28 is connected to the illumination effect driving circuit 61 through a serial interface, via the light emitting portion 20.

The hopper driving circuit 63 drives a hopper 64 in accordance with control by the main CPU 32. The hopper 64 conducts an operation for paying out coins and pays out the coins to the coin tray 16. The payout completion signal circuit 65 obtains the numerical value of the number of coins from a coin detection portion 66 connected thereto. When the numerical value reaches the value predetermined set, the payout completion signal circuit 65 inputs a signal for notifying completion of payout of coins into the main CPU 32. The coin detection portion 66 counts the number of coins paid out from the hopper 64 and inputs the number into the payout completion signal circuit 65.

Further, a sub-control board 72 is connected to the main control board 71. A liquid crystal panel 5A, a liquid crystal panel 5B and the speakers 23 are connected to the sub-control board 72.

FIG. 4 is a block diagram showing an internal configuration of the sub-control board 72. As shown in FIG. 4, the sub-control board 72 performs display control of the liquid crystal panel 5A and the liquid crystal panel 5B and output control of sound from the speakers 23, by inputting commands from the main control board 71. The sub-control board 72 is arranged on a circuit board which is different from a circuit board constituting the main control board 71. The sub-control board 72 is mainly consisted of a microcomputer (hereinafter referred to as “sub-microcomputer”) 73 and includes a sound source IC 78 for controlling sound outputted from the speakers 23, a power amplifier 79 as an amplifier, and an image control circuit 81 working as display control means for the liquid crystal panels 5A and 5B. The sound source IC 78 stores data relating to the sound effect described above.

The sub-microcomputer 73 includes a sub-CPU 74 performing control operation in accordance with a control command sent from the main control board 71, a program ROM 75 as memory means, a work RAM 76, and I/O ports 77 and 80. The sub-control board 72 is not provided with a clock pulse generation circuit, a frequency divider, a random number generation circuit and a sampling circuit. However, the sub-control board 72 is configured to perform random number sampling in the operation program of the sub-CPU 74. The program ROM 75 stores a control program executed on the sub-CPU 74. The work RAM 76 is provided as temporal memory means when executing the above control program on the sub-CPU 74.

The image control circuit 81 includes an image control CPU 82, an image control work RAM 83, an image control program ROM 84, an IN port 85, an image ROM 86, a video RAM 87, and an image control IC 88. Based on the parameter set by the sub-microcomputer 73, the image control CPU 82 determines images to be displayed on the liquid crystal panels 5A and 5B, in accordance with an image control program stored in the image control program ROM 84.

The image control program ROM 84 stores an image control program concerning display of the liquid crystal panels 5A and 5B and various selection tables. The image control work RAM 83 is provided as temporal memory means when executing the image control program on the image control CPU 82. The image control IC 88 forms images based on the determination by the image control CPU 82 to output on the liquid crystal panels 5A and 5B.

The image ROM 86 stores dot data for forming an image. The video RAM 87 works as temporal memory means when forming an image with the image control IC 88.

[4. Basic Operation of the Gaming Machine]

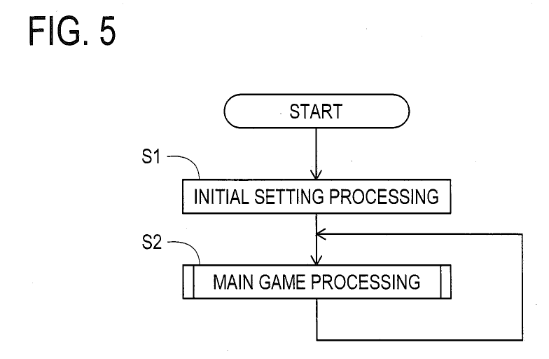

Next, there will be described precisely a main control program to be executed in the gaming machine 1 by referring to the drawings. FIG. 5 is a flowchart of the main control program.

First, when a power switch is turned on (switch-on), the microcomputer 31 is activated and the microcomputer 31 executes an initial setting processing at step (hereinafter referred to as S) 1. In the initial setting processing, the main CPU 32 executes the BIOS stored in the ROM 34 and extracts compressed data included in the BIOS into the RAM 33, thereby to execute the BIOS extracted in the RAM 33 and to carry out diagnosis and initialization of the peripheral devices. Next, the main CPU 32 writes game program and the like read from the ROM 34 to the RAM 33 and obtains payout rate setting data and country identification information. It is to be noted that the main CPU 32 also carries out authentication processing on the programs during the initial setting processing.

In S2, the main CPU 32 sequentially reads out and executes the game program and the like from the RAM 33 thereby to carry out a main game processing. By carrying out the main game processing, a game is conducted in the gaming machine 1. The main game processing is repeatedly carried out while power is supplied to the gaming machine 1.

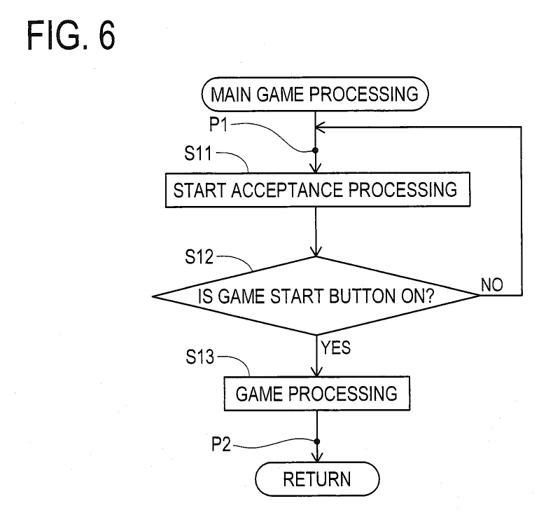

Next, there will be described a subroutine concerning the main game processing of S2 by referring to FIG. 6. FIG. 6 shows the flowchart of the main game processing to be carried out in the gaming machine 1. It is to be noted that the programs indicated in the flowchart of FIG. 6 are stored in the ROM 34 or RAM 33 and executed by the main CPU 32.

As shown in FIG. 6, the main CPU 32 firstly carries out a start acceptance processing at S11. At the start acceptance processing, insertion of a coin and bet operation with the BET button among the operation buttons 11 are done by a player.

Next, in S12, the main CPU 32 judges whether or not the game start button among the operation buttons 11 has been pressed. As to the game start button, a spin button corresponds to it when a video slot is conducted in the gaming machine 1, for example. This judgment is carried out based on a signal to be inputted to the main CPU 32 in response to the press of any one of the operation buttons 11. In case the game start button among the operation buttons 11 is not pressed (S12: NO), the processing returns to the start acceptance processing (S11) again. Under this state, a player can change the number of bets or the like. In case the game start button among the operation buttons 11 is pressed (S12: YES), the main CPU 32 stores the number of bets set by the above bet operation into the RAM 33 as bet information. Next, the processing goes on to S13.

In S13, the main CPU 32 carries out a game processing. At the game processing, the main CPU 32 carries out control for displaying the game state onto the liquid crystal panel 5B by sending a control signal based on the lottery result and the like of the above-described lottery program to the sub-control board 72. The main CPU 32 carries out control for changing the execution state of the game being displayed on the liquid crystal panel 5B by sending a control signal to the sub-control board 72 based on the signal to be inputted in response to a press of a button for operating the game among the operation buttons 11.

In this manner, a game proceeds or terminates on the liquid crystal panel 5B. Then, the main CPU 32 awards a payout corresponding to a game result to a player. After that, the main CPU 32 carries out the main game processing shown in FIG. 6.

[5. Characteristic Operation of the Gaming Machine]

The main CPU 32 carries out processings indicated in S31 through S34 in FIG. 8, at the time of P2 after carrying out the above-described game processing of S13. Here will be explained the processings of S31 through S34 by referring to FIG. 8. It is to be noted that the programs indicated in S31 through S34 of FIG. 8 are stored in the ROM 34 or RAM 33 included in the gaming machine 1 and executed by the main CPU 32.

First, the main CPU 32 carries out a game history information renewal processing at S31. In the game history information renewal processing, the number of times that large amount of payout is paid out at one time during a certain period, that is, the number of wins is counted. The number of wins is stored in the RAM 33 as the game history information. It is to be noted that the large amount of payout is paid out at one time for example in a jackpot in which payout which is hundreds of times of bet is paid out at one time, a free game in a video slot, and a free game and the like. Also, the certain period refers to within 24 hours, within three days, and within one week and the like. Next, the processing proceeds to S32.

In S32, the main CPU 32 judges whether the mode is set in the insurance mode or not. This judgment is carried out based on a signal to be inputted to the main CPU 32 in response to the press of the insurance mode setting button which is one of the operation buttons 11. It is to be noted that a certain number of bets must be further wagered in order that press of the insurance mode setting button is validated. Here, when not in the insurance mode (S32: NO), the processing proceeds to S34 to be described later. When in the insurance mode (S32: YES), the processing proceeds to S33.

In S33, the main CPU 32 carries out an insurance payout information renewal processing. In the insurance payout information renewal processing, the number of remaining games is calculated which needs to be repeated in order that an insurance payout is awarded. The number of remaining games is stored into the RAM 33 as the insurance payout information. For example, in a video slot game, insurance payout is awarded in a case where the unit game has been repeated for 1000 times. Next, the processing proceeds to S34.

In S34, the main CPU 32 carries out a play information renewal processing. In the play information renewal processing, the play information is generated and updated in which the game result (including amount of payout) and current time and date and the like are brought into corresponding with the ID information of the player. The play information is stored into the RAM 33. Next, the processing goes back to the main game processing of FIG. 6 described above.

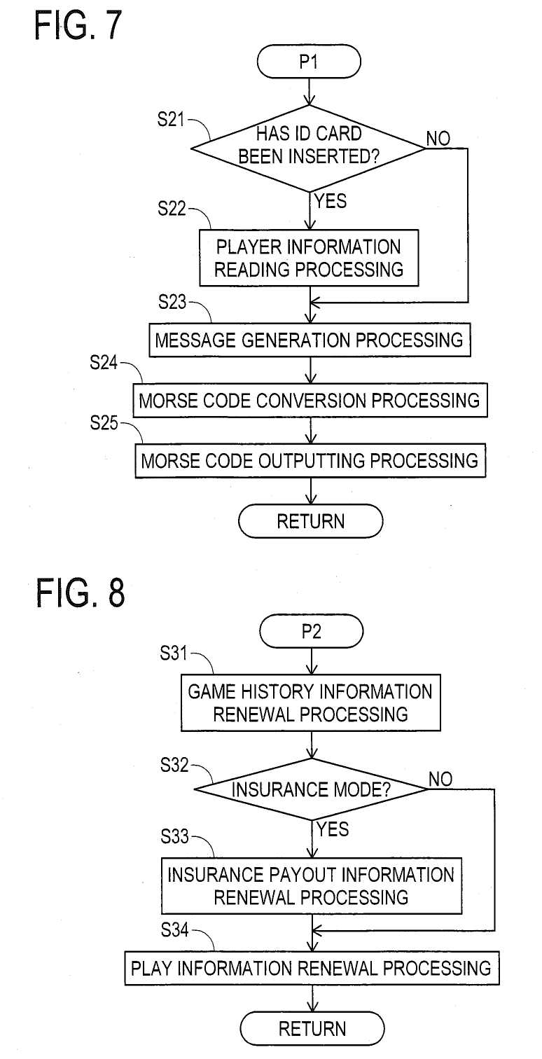

Further, the main CPU 32 carries out the processings of S21 through S25 indicated in FIG. 7 at the time of P1 immediately before carrying out the above-described start acceptance processing of S11. Here will be explained the processings of S21 through S25 by referring to FIG. 7. It is to be noted that the programs indicated in S21 through S25 indicated in FIG. 7 are stored in the ROM 34 or RAM 33 included in the gaming machine 1 and executed by the main CPU 32.

First, in S21, the main CPU 32 judges whether or not the ID card 112 has been inserted. This judgment is carried out based on a signal and the like to be inputted from the card reader 15 to the main CPU 32 and the like in response to the ID card 112 being inserted into the card reader 15. Incidentally, if the ID card 112 is kept inserted in the card reader 15, it is judged that the ID card 112 has not been inserted. Here, if the ID card 112 has not been inserted (S21: NO), the processing proceeds to S23 to be described later. If the ID card 112 has been inserted (S21: YES), the processing proceeds to S22.

In S22, the main CPU 32 carries out a player information reading processing. In the player information reading processing, the player information stored in the ID card 112 is read by the card reader 15. Further, the ID information is read from the player information. Next, the processing proceeds to S23.

In S23, the main CPU 32 carries out a message generation processing. In the message generation processing, a message is generated based on the ID information, the game history information, or the insurance payout information read from the player information.

For example, a message based on the ID information read from the player information is generated in the following manner. First, the play information including the ID information is read from the RAM 33. The latest time and date is specified form the time and date included in the play information. A play interval is calculated from the difference between the latest time and date and current time and date. A message corresponding to the play interval is selected from a table shown in FIG. 9.

FIG. 9 is the table stored in the ROM 33, the table showing correspondences between play intervals and messages. According to the table shown in FIG. 9, in a case where the play interval is under 24 hours, the message of “Welcome” is selected. In a case where the play interval is one day or more and less than three days, the message of “Good luck” is selected. In a case where the play interval is three days or more, the message of “Long time!” is selected.

Also, a message based on the game history information is generated in the following manner. First, the game history information is read from the RAM 33. The number of wins is specified from the game history information. The message corresponding to the number of wins is selected from a table shown in FIG. 10.

FIG. 10 is the table stored in the ROM 33, the table showing correspondences between the number of wins and messages. According to the table shown in FIG. 10, in a case where the number of wins is from zero to two times, the message of “A few wins” is selected. In a case where the number of wins is from three to seven times, the message of “Many wins” is selected. In a case where the number of wins is eight times or more, the message of “Great many wins” is selected.

Also, a message based on the insurance payout information is generated in the following manner. First, the insurance payout information is read from the RAM 33. The number of remaining games is specified from the insurance payout information. The message corresponding to the number of remaining games is selected from a table shown in FIG. 11.

FIG. 11 is the table stored in the ROM 33, the table showing correspondences between the number of remaining games and messages. According to the table shown in FIG. 11, in a case where the number of remaining games is 800 times or more, the message of “800 games or more to insurance payout.” is selected. In a case where the number of remaining games is 200 games or more and 799 games or less, “200 games or more to insurance payout.” is selected. In a case where the number of remaining games is one game or more and 199 games or less, the message of “Almost there to insurance payout.” is selected.

In these manners, the message generation processing is carried out. Then, the processing proceeds to S24 of FIG. 7. In S24, the main CPU 32 carries out a Morse code conversion processing. In the Morse code conversion processing, the message generated in the message generation processing at S23 above is converted to Morse code. In this conversion, English Morse code is employed. The processing then proceeds to S25.

In S25, the main CPU 32 carries out a Morse code outputting processing. In the Morse code outputting processing, the main CPU 32 sends a control signal to the sub-control board 72 so as to control sound effect outputted from the speaker 23 in a manner that high-low, strong-week, on-off and the like of sound outputted from the speaker 23 correspond to the Morse code generated in the Morse code conversion processing at S24 above. Further, the main CPU 32 sends the control signal to the light illumination effect driving circuit 61 so as to control light effect performed by the light emitting portion 20 and the topper effect device 28 in a manner that change of color, light and dark, blinking and the like of light outputted from the light emitting portion 20 or the topper effect device 28 correspond to the Morse code generated in the Morse code conversion processing at S24 above. Then, the processing goes back to the main game processing of FIG. 6 above.

[6. Others]

It is to be noted that the present invention is not limited to the above described embodiment and may be modified in various ways within a scope not departing from the present invention.

For example, the main CPU 32 may carry out the Morse code conversion processing of S24 above by using Morse code of the language used in the country in which the gaming machine 1 is installed.

Also, the main CPU 32 may carry out the Morse code outputting processing of S25 by outputting from the speaker 23 a signal sound corresponding to the Morse code generated in the Morse code conversion processing at S24.

Also, in the Morse code outputting processing of S25, the main CPU 32 may control change of color, light and dark, blinking and the like of display light of the liquid crystal panel 5A or the liquid crystal panel 5B so as to correspond with the Morse code generated in the Morse code conversion processing of S24.

In addition, an IC card may be used as the ID card 112. In this case, if a card reader/writer is used as the card reader 15, the main CPU 32 can store the play information generated and updated by the play information renewal processing at S34 into the IC card.

Further, the gaming machine 1 of the embodiment may be game machines conducting various games such as a card game, a roulette game, a dice game, or a mah-jong game.

What is claimed is:

1. A gaming machine comprising:
an effect device for outputting effect;
a processor programmed to operate
(1) to control an output state of the effect device by bringing into corresponding with Morse code that represents a message.

2. The gaming machine according to claim 1, comprising:
a reader into which an ID card storing player information is inserted,
wherein, in carrying out the operation of (1), the processor
(a) reads the player information with the reader when the ID card has been inserted into the reader,
(b) generates the message based on the player information, and
(c) converts the message into Morse code.

3. The gaming machine according to claim 1, comprising:
a memory device for storing game history information,
wherein, in carrying out the operation of (1), the processor
(a) reads the game history information from the memory device,
(b) generates the message based on the game history information, and
(c) converts the message into Morse code.

4. The gaming machine according to claim 1, comprising:
a setting device with which a player can set to an insurance mode in which an insurance payout is awarded on condition that a unit game is repeated for a certain number of times,
wherein, in carrying out the operation of (1), the processor
(a) generates insurance payout information on the number of unit games which need to be repeated in order that the insurance payout is awarded, when the player set to the insurance mode with the setting device,
(b) generates the message based on the insurance payout information, and
(c) converts the message into Morse code.

5. The gaming machine according to claim 1, comprising:
a reader into which an ID card storing player information is inserted; and
a memory device which stores game history information,
wherein, in carrying out the operation of (1), the processor
(a-1) reads the player information with the reader when the ID card has been inserted into the reader,
(a-2) reads the game history information from the memory device,
(b) generates the message based on the player information or the game history information, and
(c) converts the message into Morse code.

6. The gaming machine according to claim 1, comprising:
a reader into which an ID card storing player information is inserted; and
a setting device with which a player can set to an insurance mode in which an insurance payout is awarded on condition that a unit game is repeated for a certain number of times,
wherein, in carrying out the operation of (1), the processor
(a-1) reads the player information with the reader when the ID card has been inserted into the reader,
(a-2) generates insurance payout information on the number of unit games which need to be repeated in order that the insurance payout is awarded, when the player set to the insurance mode with the setting device,
(b) generates the message based on the player information or the insurance payout information, and
(c) converts the message into Morse code.

7. The gaming machine according to claim 1, comprising:
a memory device for storing game history information; and
a setting device with which a player can set to an insurance mode in which an insurance payout is awarded on condition that a unit game is repeated for a certain number of times,
wherein, in carrying out the operation of (1), the processor
(a-1) reads the game history information from the memory device,
(a-2) generates insurance payout information on the number of unit games which need to be repeated in order that the insurance payout is awarded, when the player set to the insurance mode with the setting device,
(b) generates the message based on the game history information or the insurance payout information, and
(c) converts the message into Morse code.

8. A gaming machine comprising:
an effect device for outputting effect;
a reader into which an ID card storing player information is inserted;
a memory device for storing game history information;
a setting device with which a player can set to an insurance mode in which an insurance payout is awarded on condition that a unit game is repeated for a certain number of times; and
a processor programmed to operate
(a-1) to read the player information with the reader when the ID card has been inserted into the reader,
(a-2) to read the game history information from the memory device,
(a-3) to generate insurance payout information on number of unit games which need to be repeated in order that the insurance payout is awarded, when the player set to the insurance mode with the setting device,
(b) to generate the message based on the player information, the game history information or the insurance payout information,
(c) to convert the message into Morse code, and
(d) to control an output state of the effect device by bringing into corresponding with the Morse code.
